(19) United States
(12) Patent Application Publication
(10) Pub. No.: US 2026/0212411 A1
(43) Pub. Date: Jul. 23, 2026

(54) METHOD OF ESTABLISHING COLLATERAL FOR CREDITORS

(71) Applicant: Anchor Accounting Services LLC, Midlothian, VA (US)

(72) Inventor: Thomas Ryan Leggett, Midlothian, VA (US)

(73) Assignee: Anchor Accounting Services LLC, Midlothian, VA (US)

(21) Appl. No.: 19/457,571

(22) Filed: Jan. 23, 2026

Related U.S. Application Data
(60) Provisional application No. 63/748,660, filed on Jan. 23, 2025.

(51) Int. Cl. G06Q 40/03; G06Q 20/10

(52) U.S. Cl. CPC G06Q 40/034; G06Q 20/10

(57) ABSTRACT

A method of establishing collateral for a creditor of a client, comprising creating a trust account stored on a control module, wherein the trust account complies with rules of a regulatory authority, and the trust account is held in the name of the client, transferring funds to the trust account to serve as the collateral, and creating registered creditors having corresponding accounts operatively connected to the trust account. The trust account has predetermined rules of how to distribute such funds to corresponding accounts of the one or more creditors from the trust account, and after the one or more creditors have been paid, then transferring any remainder to a pre-established client account.

### RELATED APPLICATION

This patent application claims priority benefit of US Provisional Patent Application No. 63/748,660, filed on January 23, 2025.

### FIELD OF THE INVENTION

This invention relates to methods of establishing collateral for vendors and other creditors.

### BACKGROUND OF THE INVENTION

Tax preparers and lenders can be reluctant to work with some consumers for fear of not being paid for services rendered. This can be true even when funds, such as a tax refund is paid or expected to be paid. Often the funds are mailed or otherwise deposited directly to the consumers address of record, or issued to the taxpayer’s permitted financial account. This is because those funds go directly to the taxpayer and the additional step of having the taxpayer pay the tax preparer or lender for work done is required. This raises the risk that the taxpayer does not pay its invoices timely or at all, resulting in costly collection efforts having to be undertaken by the tax preparer, with no guarantee of actual payment by the taxpayer. It therefore would be desirable to provide a secure method where vendors and other creditors can have their debts paid by the taxpayer in a more direct manner.

### SUMMARY OF THE INVENTION

In accordance with a first aspect, a method of establishing collateral for a creditor of a client, comprises creating a trust account stored on a control module, wherein the trust account complies with rules of a regulatory authority, and the trust account is held in the name of the client, transferring funds to the trust account to serve as the collateral, and creating registered creditors having corresponding accounts operatively connected to the trust account. The trust account has predetermined rules of how to distribute such funds to corresponding accounts of the one or more creditors from the trust account, and after the one or more creditors have been paid, then transferring any remainder to a pre-established client account.

From the foregoing disclosure and the following more detailed description of various embodiments, it will be apparent to those skilled in the art that the present invention provides a significant advance in the relationship between taxpayers and their vendors and creditors. Particularly significant in this regard is the potential the invention affords for providing a method that protects vendors and other identified creditors by providing a straightforward way to receive at least partial payment, as well as the potential for additional tax assistance and access to capital that currently is limited, more costly, or unattainable for the layperson taxpayer. Additional elements and advantages of various embodiments will be better understood in view of the detailed description provided below.

### BRIEF DESCRIPTION OF THE DRAWINGS

FIG. 1 is a schematic flow chart of a method of establishing collateral for one or more vendors and creditors of a client, showing the use of a trust account.

FIG. 2 is schematic flow chart of one embodiment of the methods disclosed herein where there are two owners of a business, with refunds/tax credits send first to the owner’s trust account(s), and then to a separate corporate trust account of the business.

FIG. 3 is a schematic flow chart of one embodiment of the methods disclosed herein where there are two businesses with overlapping but not identical owners.

It should be understood that the appended drawings are not necessarily to scale, presenting a somewhat simplified representation of various features illustrative of the basic principles of the invention. The specific design features of the elements disclosed here including, for example, the specific interface and permissions of the trust account, will be determined in part by the particular intended application and use environment. Certain features of the illustrated embodiments have been enlarged or distorted relative to others to help provide a clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the method of establishing collateral for creditors disclosed here. The following detailed discussion of various alternate elements and embodiments will illustrate the general principles of the invention with reference to a method useful for providing collateral to vendors and creditors of a client/consumer, such as a tax preparer. Other embodiments suitable for other applications will be apparent to those skilled in the art given the benefit of this disclosure.

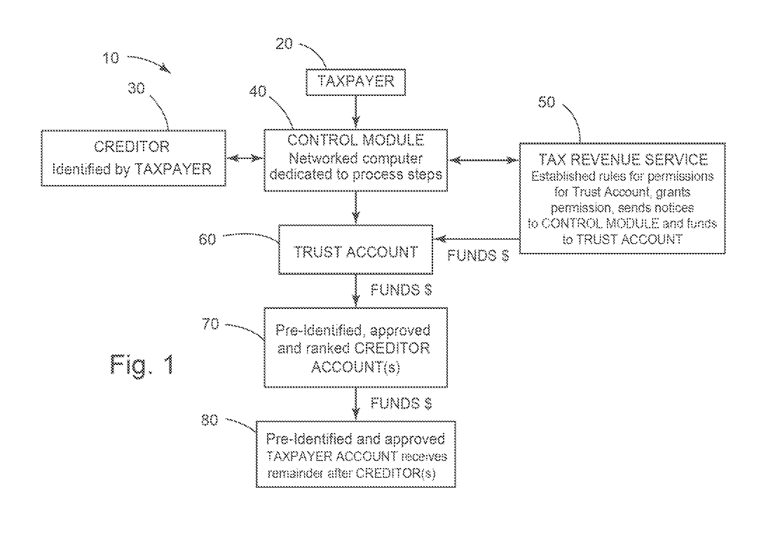

Turning now to the drawings, FIG. 1 shows a simplified high-level schematic of the method 10 disclosed herein for establishing collateral for creditors/vendors 30 of a consumer 20. The method disclosed herein uses a control module 40 formed in part as a series of networked computers, displays, (and human agents as needed) and operatively connected bank accounts for transfers of funds. Each networked computer is a machine dedicated to performing one or more of the process steps of the invention disclosed herein. The method disclosed herein begins with client onboarding and verification at the control module 40. The entity that controls and/or owns the control module 40 would typically enter into a contract with the client that wants to set up a trust account 60 with the vendor 30, such as with a tax return preparation service. The trust account 60 in the client’s name is set up and established using taxpayer permissions for direct payment of money/funds to the taxpayer account.

Advantageously, the method disclosed herein creates trust accounts 60 that are compliant with tax revenue service requirements and are part of a computer network to allow for high volumes. A first step can be considered as a treasury service process, where a taxpayer trust account 60 is created. For example, a client taxpayer (or tax preparer having data corresponding to one or more taxpayers which the tax preparer prepares taxes for) can upload information about a taxpayer. This information includes a verification step. A Know Your Customer (“KYC”) check is the process of identifying and verifying a customer's taxpayer identity when opening an account and periodically verifying over time. KYC requirements are regulations demanding institutions verify client identities, assess risks (like money laundering/terrorism financing), and monitor activities, involving identity verification (name, DOB, address, SSN or other ID number), customer due diligence (CDD), and often Enhanced Due Diligence (EDD) for higher risks, using documents like passports, driver's licenses, and business registration details for a comprehensive understanding of client behavior and affiliations. Here verification of the client can be, for example, a one-time password (OTP), an IP address check, a digital wallet such as ID.me, SSN number, facial scan or other biometrics. Such data can be checked against a reference in a regular manner. Optionally the process of verification may be accessible by an agent of the control module 40 to spot check for accuracy and to help ensure smooth correction of operations when there are issues with verification. A third-party auditor may be used in some instances. KYC requirements exist for the IRS when completing the tax work, for lenders for lending, and according to regulations for providing treasury services and/or banking functionality.

The collateral can be a tax refund which is transferred to the trust account once the tax revenue service (such as the US IRS) establishes that a properly submitted tax return (or tax credit application) has been submitted to the IRS in accordance with IRS procedures and processed. Of note, the trust account is established for the client and in the client’s name themselves, and not in the name of any of the creditors. The IRS will not allow a third party to be assigned to a check or a third-party account direct deposited into an account with a different registration than the taxpayer.

Each client trust account will have a series of permissions for any registered creditors and for the client. These permissions are for the taxpayer i.e., the consumer/client consenting to have the treasury services provider settle any known obligations, i.e., fees or loans against the incoming tax refund check prior to the final proceeds being remitted to the taxpayer’s external account. For example, a tax preparer or other vendor/creditor can be granted permission to be paid at least a portion of the funds in the trust account. It is envisioned that this portion of the method would normally be established by the taxpayer, as the client wants to hire the tax preparer and will readily identify the tax preparer as a registered creditor for the trust account. The taxpayer is willing to do this in order to be able to enlist the services of the tax preparer (or other vendor). Once the creditor(s) have had funds transferred to their creditor account, a remainder of the funds may be transferred to another of the taxpayer’s account(s), emptying the trust account. Preferably distribution of these remainder funds occurs quickly after receipt from the tax revenue service, such as within three business days, more preferably even quicker. Further, because the trust account has served its purpose as collateral for the tax preparer to get paid for their work, the trust account can be deleted after a predetermined period (such as, for example, 30 days after the transfers are complete, or 3 days after the transfers out of the trust account are complete and the account has 0 funds remaining) and the trust account can be removed from a list of accounts. In accordance with one element, the control module 40 checks that the funds are not transferred to a trust account unless the preselected instructions for where and how to distribute funds to each vendor/creditor account and a client account from the trust account have been established previously. This reduces the risk of incorrectly transferred money.

The tax revenue service (e.g., the IRS) processes the application to create the trust account in the name of the taxpayer. This is done using an application programming interface (API) which is a software intermediary that allows two applications to talk to each other. It is understood here that the IRS is not directly involved in the approval, creation, management, or closure of the taxpayer’s trust account. Rather, the trust account is set up by the entity running the system, and the IRS has no knowledge of the Treasury Services Agreement, lending agreements (if applicable) or the direct contract that the client signs with the tax/accounting/consulting vendor doing the tax worth other than the tax preparer signed the filing and listed their PTIN. The method disclosed herein allows, via API and other electronic methods to track/follow the IRS processing of the particular tax filing. This allows the control module 40 to keep an eye on the filings and transfer of funds, and give notice to the taxpayer and or the accounting/tax preparation firm or other creditors should additional information be required or issues arise from the IRS. A notification that the request to set up the trust account was denied may also be sent to the control module 40 (and from there to the taxpayer or other customers as needed or desired). In such a situation, an agent of the control module 40 may be required to contact the tax revenue service 50 to correct the error. Other notifications include updating of a tax revenue service transcript and notification of delivery of funds to the trust account. The control module 40 may issue an error notice to the taxpayer and/or creditor at each transcript update about the error. For the less and less common situation where a check is mailed from the IRS, the taxpayer would not have a check sent in the mail to their address. Rather, the check would be mailed to a lockbox to then be deposited into the trust account established for the taxpayer/customer.

The obligations of the client/taxpayer (for which funds in the trust account are used as collateral) are identified either from the taxpayer or the creditor/tax preparer (typically as part of the contract with the entity providing the control module 40). The tax preparer has an incentive to list as a registered creditor with the entity creating the trust account as the funds eventually deposited there by the tax revenue service will serve as collateral to help ensure that the tax preparer is at least partially paid (and preferably entirely paid) in a timely manner for services performed by the tax preparer on behalf of the taxpayer. The client/taxpayer also has an incentive to list with the entity providing the control module 40 and trust account as it can be necessary for a taxpayer to do business with a vendor or creditor. Further, it is anticipated that many lenders in the private credit markets would participate in the tax credit space when they have more confidence knowing that they have some collateral to secure their loans. Use of the method disclosed herein also advantageously allows for an automatic check of obligations. The fund transfer can be monitored at each stage in the process, helping to ensure that the funds are sent to the correct account and to the correct consumer. Also, if the tax revenue service wants additional information, the control module 40 can provide it, as well as quickly notify the tax preparer doing the work.

The tax revenue service process involves obtaining necessary permissions, typically in the form of contracts between relevant parties (client and vendor, provider of the control module 40 and the vendor, etc.) Typically, the client’s executed contract must be on file with the vendor for the tax work that was completed, along with a copy or verification access to the completed “work product” that was performed under the tax preparation service contract confirming that the fees for services are due to the tax preparer. In this way the vendor may become a registered creditor. Other items required before a trust account may be activated can include, for example, a treasury services Contract/Agreement authorizing the vendor/tax preparer to complete the work, typically signed by the business owner and if applicable the individual owners, or the individual when there is no corporation; a limited Financial Power of Attorney (LFPOA), a statement indicating that consent is granted/the entity has permission to settle and pay any obligations that the client may have (especially fees for the tax preparation services completed and or paying off a loan and/or other applicable fees); KYC documentation which can be sent from the lender or tax preparation firm if the client is just providing the tax revenue service with proof and not the other pieces of the method; Form 8822 or 8822-B (personal or business), which could be multiple copies depending on length of IRS processing time (these forms are to change the address to a designated lockbox/address associated with the financial institution/tax preparer performing the treasury service but only in the event that a physical check is cut); one of forms depend on Credit: 8821, 2848, and 4506C; any lending paperwork (that is, if a loan is being paid off then the client would need to have the loan agreement on file or access to the agreement to verify as necessary); and any documentation related to the loan document as needed by the loan agreement/issuer. The methods disclosed herein more preferably allow for securely creating the treasury services/trust account and list that on the tax returns without paper filings, making the process faster, safer, and less burdensome on the taxpayer and the financial institution/tax preparer as all mail is not being rerouted to the lockbox address. The methods disclosed herein preferably create the trust account up front and have it listed on the tax returns prior to being filed whether they are first year filings or amended tax filings.

Multiple registered creditors may be assigned a preference order using predetermined rules. For example, the predetermined rules could comprise a first come, first served, or pro rata, or with the approval of the tax preparer, etc. The preference order would rank creditors and determine how funds in the account would be allocated. The creditors would need to become registered, with corresponding accounts operatively connected to the trust account such that when the funds are received, the funds may be distributed to the corresponding accounts of the registered creditors (with any remaining amount to the client) as determined by the predetermined rules setting an order of (registered) creditor payments, until the trust account is exhausted. If funds are remaining in the trust account, then such remaining funds may be transferred to a pre-established client account of the client’s choosing.

Individual trust accounts are created that match the client registration exactly as it appears on the tax filing being completed. Advantageously, the control module 40 may use data about the client supplied directly from the tax revenue service (such as the IRS). The trust accounts can be created up front and then applied to an amended business or personal tax return of the client prior to submission of tax returns to the tax revenue service to help to ensure that the credit is “direct deposited” to the trust account on the return. The method disclosed herein may also collect IRS Form 8888 signed by the taxpayer as an additional filing confirming a designated client bank account is properly applied for direct deposit (and therefore is suitable as a trust account). The Treasury service can also be completed/contracted for companies/taxpayers where the filing already was completed. In this case the method would obtain all the other documentation and use Form 8888 alongside the other forms to redirect the direct deposit to the trust account established for the taxpayer. Advantageously, this method saves many weeks of time compared to mailing a refund check (along with the risk of the refund check being lost in the mail. The IRS has specific requirements on the account registration that a direct deposit or paper check is deposited into from the Treasury and cannot be a third-party account. The client is required to sign IRS Form 8888 as additional confirmation of this method for the IRS prior to creation of the trust account.

In accordance with a highly advantageous element, the tax processing at the IRS can be monitored by the entity through direct (application programming interface) API access between the control module 40 and the IRS. This allows for monitoring and rapidly addressing any processing problems. Moreover, such continuous regular monitoring a status of the trust account by the control module allows for information about any processing problems to be shared with the tax preparer or other creditor(s). Processing problems can be addressed between the tax preparer and the tax revenue service and quickly corrected. Advantageously, monitoring the status of the trust account allows for notice to be sent to creditors (including the tax preparation firm), as well as the client that the tax refund has been deposited in the trust account.

Assuming no processing problems by the tax revenue service, and once the tax revenue service processes the claim, funds are preferably directly deposited in the trust account matching the taxpayer’s information. If the tax refund check or direct deposit funds are deposited into the trust account in the name of the business, then a list of obligations to any and all creditors and vendors attached to the taxpayer/client file is checked. Any such financial obligations of the taxpayer are paid to the extent there are funds in the account. Typically, this happens as soon as the funds are clearly deposited into the trust account and takes the form of an electronic transfer of funds from the trust account to one or more creditor accounts 70 based on the predetermined list of obligations of the taxpayer. The predetermined list of obligations of the taxpayer may be ranked by predetermined rules to determine an order of preference of withdrawal from the trust account, with funds sent to the creditor’s account(s) via automated clearing house (ACH) transfers. Any net balance is then remitted to the taxpayer/business via an ACH to an external account 80 of the taxpayer’s choice. The trust account 60 is intended to be a short-term instrument. Therefore, after the funds have been transferred out of the trust account, the trust account is closed after a predetermined period of time (for example, 30 days after funds are transferred out of the trust account) and removed from a chart of accounts.

The refund is tracked and sent directly via EFT to the trust account (when the funds are a tax refund, the transfer occurs directly assuming no back taxes are due). This provides collateral which is highly predictable. Advantageously therefore, creditors and potential creditors may confidently extend capital to the client against this asset type. That is, creditors can pledge capital to the client based on the anticipated tax refund being deposited in the trust account as collateral. The client is effectively given the option of obtaining an advance on the anticipated transfer of funds to the trust account. This can be a huge benefit to clients who may needing immediate access to capital and otherwise would be stuck waiting months if not longer for the IRS to finish processing their file. This also can help price capital at a lower rate since the risk of default/loss is reduced. The advance can then be listed as an obligation to be satisfied (that is, as a registered creditor) when IRS processes the tax refund and send the tax refund to the trust account. Generally, the client is given the opportunity to pay their invoice at time that the tax firm is submitting the tax return to the IRS, or, if the refund is at least enough to pay the invoice the client can complete a Treasury Services agreement (to have funds eventually deposited into the trust account be automatically then sent to the creditor’s account for the tax firm). If the client is seeking an advance to access their funds sooner then the client must complete the Treasury Services Agreement to be eligible to apply for the advance.

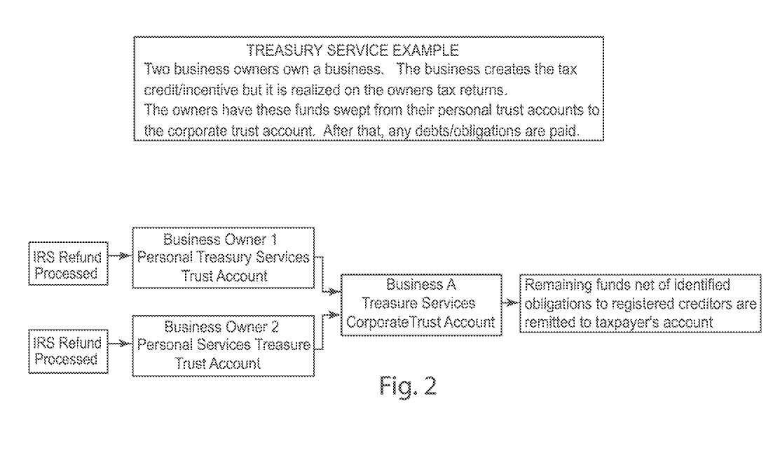

If the tax refund check/funds to be transferred to the trust account is made out to one or more of the owners of a business (instead of to the business directly), a modified process can be followed where a separate corporate trust account is used in addition to the trust account for individuals, along with agreements which extend between not just the creditors and the individuals, but also between individuals when there is more than one owner of the business (See FIG. 2). First, an authorization/agreement on file with the taxpayer allows funds to be transferred to the trust account registered in the name of the taxpayer, even when the funds list the owners of the business as well. Next, the funds are transferred to a separate corporate trust account prior to any proceeds being distributed to the taxpayer. Once the list of obligations attached to the business are pulled, any obligations (fees, expenses, a loan payoff, etc.) are paid out of the funds transferred to the corporate trust account. Then, as before, any balance is remitted to the business via ACH to an external account of the choice of the business. Finally, after the funds have been transferred out of the trust account the trust account is closed after a predetermined period of time, such as 30 days later, and removed from the chart of accounts. Some tax credits and incentives from the IRS are created at the business level but realized at the owner's tax return.

Advantageously, the control module is able to assign individual credits back to the business as needed. For example, FICA Tip Tax Credits are based on Form 8846 - where the business is able to get a credit for the Social Security portion of the FICA paid on Tipped wages per Section 45B of the IRS code. The business takes and refiles the business tax return for the credit and the funds of the tax credit are passed to the owner(s) via a K1 or pass through to the personal tax return of the taxpayer(s). Then the business owner is able to get a reduction in the personal taxes due that year or it is applied as a carryforward for a carry forward period of time (such as 20 years). For situations where the business has multiple owners, the multiple owners enter into an agreement where the owners assign the refund to the business (i.e., after the funds are transferred to one or more of the owners, the funds are transferred to the corporate trust account). When the funds come in to the corporate trust account, balances are paid to the creditors (to the predetermined creditor’s account(s) and then remitted to the business (and not to the owner(s).

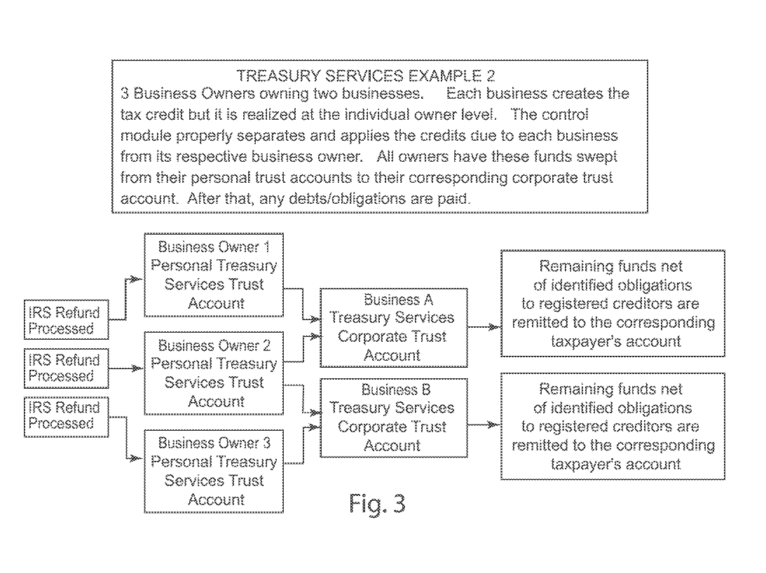

Further, when there are multiple businesses and multiple partially overlapping owners of the businesses, any tax credit or tax refund may be automatically split and sent from the IRS to the owners first, and from there to the corresponding corporate trust account owned by the owner for deduction of creditor’s obligations. See FIG. 3. Furthermore, amended tax returns are possible and the control module can take into account each year’s amended returns (with corresponding tax refunds and/or tax credits for each owner of each business. The refund/tax credit for each year would be sent to each beneficial owner of each business separately, prior to transfer to the corporate trust account (per an agreement between the owners and the creditors of each business). Finally, the control module can keep a full audit trail of all funds received and sent out with a transcript file for each year showing the tax credit/tax refund distributions, the interest available to the creditor/tax preparation firm, and/or the financial institution if an advance was provided.

Advantageously several kinds of reports may be provided by the control module 40 to the taxpayer and/or to the creditor(s). These reports can include a detailed accounting to the taxpayer/client; necessary information (including amounts transferred to the trust account and from there to the creditor account(s)); and a report to any lending party/creditor with information, such as the amount of funds transferred to the trust account and the amount transferred to each creditor account.

The process disclosed herein is highly advantageous because not only can the entity use the control module 40 to centralize receipt of the funds, but the process can also act on behalf of the taxpayer to get needed work done. In addition, the control module 40 helps taxpayers and tax preparation firms reduce the risk of missing information that the IRS previously sent directly to the client/taxpayer which could cause a taxpayer’s credit rating to be impacted. Further, creditors/vendors and other lenders risk of default or extended repayment can be reduced because at least partial payment from the trust account may occur. Risk is also reduced by the control module 40 being configured to interface with the tax revenue service’s API to allow for substantially real-time updates on the tax return’s processing. More consistent payments with inherent reduction in defaults and the need for attempts at collection may allow for materially lower regular fees, which also benefits the taxpayer.

The first steps of the method disclosed herein involves onboarding of clients by the company. Control module 40 coordinates creation of the scope of the work to be done for the client, information about the client, and necessary permissions/pre-approvals from the IRS. The client enters into a contract with the creditor/vendor, and the creditor/vendor creates a regulatorily approved trust account for transfer of funds, such as a tax refund or a tax credit. Necessary forms from the IRS (such as 4506 C/T, 8822, 8822B and/or 8821, for example) are completed and submitted to the IRS. The goal is to establish a trust account that can receive a tax refund, tax credit or similar funds from the IRS and be used as collateral for a creditor such as a tax preparer, thereby providing incentive for the tax preparer to work for the taxpayer. Optionally the method disclosed herein can further assist a tax preparing firm with helping prospective clients/taxpayers discover specific tax credits and incentives, complete specific tax services, or to scan the client’s tax situation to discover missed tax credits, deductions, or options that the tax preparer may have missed. Then the client can securely and compliantly get verified, submit their tax information, sign agreements, and then interact with the tax team completing the work for them. Business credits can have other team

members like the client’s CPA, lawyer, and/or authorized representative assist in preparing information. For tax credits in the business space the control module can vet and invite all applicable owners, and/or spouses of owners if the tax credit is being claimed on the individual tax return. The IRS approved trust account allows for immediate transfer of such funds from the IRS to the preselected creditor/vendor. Note that creditors not preselected (and who do not go through the registration process) would not be able to use trust account received funds as collateral. This creates an incentive for creditors to join the system, that is, to become registered creditors. In some circumstances the tax filing may have already occurred. In this case if the client wants an advance the client will need to sign the 8888 form to submit the banking information, and the form 2848 may also be required to allow both monitoring of the submission and the ability to confirm with the taxpayer revenue service that the new banking information has been applied correctly and remains in force throughout the process.

Optionally payment can be made from the IRS in the form of a check (although an electronic transfer is preferred) which, once received by the company, is deposited in the trust account. From there the predetermined rules of distribution are the same as with direct payments by the IRS to the trust account. After payment of the pre-identified and preregistered creditors (optionally by rank among creditors when there is more than one creditor), any remainder can be sent essentially immediately to an account of the taxpayer (whether it is an individual or a corporate entity), typically by ACH. It is intended that the trust account is a short-term instrument; funds are received and rapidly disbursed to the extent possible per pre-approved criteria. After that, there should be no money left in the trust account and the trust account can be shut down, typically after a predetermined period of time, such as 30 days.

Client enrollment can comprise KYC data can be extensive to satisfy IRS requirements for a trust account, and verification can comprise not just date of birth and social security number, but can also comprise facial recognition scans, for example. At the IRS, once the appropriate regulatory documents have been received and the application is deemed in order, the IRS assigns an account specific to the taxpayer with an account number and routing number. Thus, the IRS is now in a position to transfer funds to the trust account. Mere creation of the trust account does not result in a transfer of funds to the trust account from the IRS. Optionally, the control module 40 of the company can verify that there are no back taxes due by the taxpayer. The control module is able to scan the client’s master tax file and ensure that there are no unpaid taxes that could prevent the refund check from arriving and paying off the advance. Permissions and order of transfer of funds from the trust account to creditors can be modified in this situation, with the IRS taking priority for payment ahead of other creditors. For the transfer of funds to occur, a filing must be made with the IRS, such as a tax return with a request for a tax refund, for example.

The step of client enrollment can comprise threshold questions to determine to the creditor if the client is suitable for enrollment into the method of establishing collateral for creditors of the company. These threshold questions can comprise, for example, establishing a credit score and determining the exact legal status of the client (individual, corporation, partnership, etc.) If the client is a corporation or a partnership, establishing information about the owner(s) of the client corporation or partnership can be required by the control module algorithm. Optionally the beneficial owners of the corporation or partnership may be required to verify that they do not owe back taxes in addition to the client). If back taxes are due, then such back taxes would be deducted from the refund prior to sending a remainder, if any, to the trust account. Finally, once the funds have been transmitted out of the trust account (to a creditor(s) account, with any remainder to the taxpayer’s account), then a reminder notice may be sent to the client in the form of an offer to extend services for another year. This can help the client ensure receipt of a tax credit in future years. Other notices can be sent to the client during the process. The lender/creditor can have a dashboard display that shows a status of the loans or asset purchases that have been made, as well as status of the trust account. The dashboard display provides insights and KPI data to the lenders making it easier than ever for them to continue to extend capital on favorable terms to businesses and individuals. Advantageously, the system and method disclosed herein can also provide taxpayers access to additional tax assistance and access to capital that currently is limited, more costly or unattainable.

Advantages of the methods disclosed herein comprise at least:

• Bypassing Third-Party Payment Restrictions: The IRS generally prohibits direct deposits into third-party accounts or checks assigned to third parties. The methods disclosed herein advantageously establish the trust account in the taxpayer’s name while pre-linking it to creditor accounts, thereby satisfying IRS requirements while ensuring creditors receive payment;

• Direct API Monitoring of Tax Processing: Another highly advantageous element is the use of a direct API between the control module 40 and the IRS. This allows for real-time monitoring of the tax filing, enabling the control module to identify and address processing problems or missing information immediately;

• Creation of a New Collateral Class: The methods disclosed herein provide a straightforward way for vendors and lenders to use a future tax refund as secured collateral. This is intended to encourage private credit markets to participate in the tax credit space by providing them with more confidence in repayment; and

• Automated Compliance and Risk Reduction: By requiring the trust account instructions for distributions for each creditor to be set up before funds are transferred, the methods disclosed herein reduce the risk of incorrectly transferred money. Further, receipt of funds is effectively centralized, which helps the taxpayer ensure all reporting and information requirements are met, and which helps protect a taxpayer's credit rating.

From the foregoing disclosure and detailed description of certain embodiments, it will be apparent that various modifications, additions, and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of establishing collateral for a creditor of a client, comprising, in combination, the steps of:
creating a trust account stored on a control module, wherein the trust account complies with rules of a regulatory authority, and the trust account is held in the name of the client;
transferring funds to the trust account to serve as the collateral; and
creating registered creditors having corresponding accounts operatively connected to the trust account;
wherein the trust account has predetermined rules of how to distribute such funds to corresponding accounts of the one or more creditors from the trust account, and after the one or more creditors have been paid, then transferring any remainder to a pre-established client account.

2. The method of claim 1 wherein the regulatory authority is a tax revenue service, and the step of transferring funds comprises transferring a tax refund from the tax revenue service to the trust account to serve as the collateral.

3. The method of claim 2 wherein at least one of the one or more creditors pledge capital to the client based on the anticipated tax refund being deposited in the trust account.

4. The method of claim 2 further comprising the step of monitoring a status of the trust account by the control module.

5. The method of claim 4 further comprising the step of sending a notice to client and to the one or more creditors when funds have been deposited in the trust account.

6. The method of claim 1 wherein payment is made to accounts of the registered creditors according to predetermined rules and within a predetermined period of time upon receipt of the funds.

7. The method of claim 2 further comprising the step of supplying appropriate documentation by the client to allow the tax revenue service to send the funds to the trust account.

8. The method of claim 2 wherein the control module comprises at least one computer operatively networked to the tax revenue service, and further comprising the step of:
monitoring the processing of the transfer of funds, detecting an error in the delivery of anticipated funds to the trust account, and creating an error notice.

9. The method of claim 8 wherein the error notice is sent to at least one of the taxpayer and the creditor.

10. The method of claim 2 wherein a report about which creditor accounts and how much of the funds were sent to is generated and is delivered to at least one of the taxpayer and the creditor.

11. The method of claim 1 wherein the trust account is closed after a predetermined period of time.

12. The method of claim 2 further comprising the step of checking to determine if back taxes are due from the taxpayer, and if so, then deducting the back taxes from the refund and sending a remainder, if any, to the trust account.
